(19) United States
(12) Patent Application Publication
(10) Pub. No.: US 2025/0193865 A1
(43) Pub. Date: Jun. 12, 2025

(54) METHODS AND APPARATUSES FOR DETERMINING SLOT FORMAT

(71) Applicant: LENOVO (BEIJING) LIMITED, Beijing (CN)

(72) Inventors: Yuantao ZHANG, Beijing (CN); Ruixiang MA, Beijing (CN); Hongmei LIU, Beijing (CN); Zhi YAN, Beijing (CN); Haiming WANG, Beijing (CN)

(21) Appl. No.: 18/844,606

(22) PCT Filed: Mar. 8, 2022
(86) PCT No.: PCT/CN2022/079720

§ 371 Date: Sep. 6, 2024

(51) Int. Cl. H04W 72/0457; H04W 72/0446; H04W 72/1268; H04W 72/231

(52) U.S. Cl. CPC H04W 72/0457; H04W 72/0446; H04W 72/1268; H04W 72/231

(57) ABSTRACT

The present application relates to methods and apparatuses for determining a slot format. One embodiment of the present disclosure provides a user equipment (UE), comprising: a transceiver; and a processor coupled with the transceiver, and the processor is configured to: receive a first configuration information indicating a first set of resources, wherein the first set of resources includes a part of resources of a second set of resources within a periodicity; and determine a set of first type of flexible resources in the first set of resources.

### TECHNICAL FIELD

The present disclosure relates to the 3rd generation partnership project (3GPP) 5G new radio (NR), especially to methods and apparatuses for determining a slot format.

### BACKGROUND OF THE INVENTION

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In a wireless communication system, a base station (BS) may perform data transmission with a user equipment (UE) in a full duplex mode, which might incur interference. In order to cancel the interference, there is a need for determining a slot format in a wireless communication system.

### SUMMARY

One embodiment of the present disclosure provides a user equipment (UE), comprising: a transceiver; and a processor coupled with the transceiver, and the processor is configured to: receive a first configuration information indicating a first set of resources, wherein the first set of resources includes a part of resources of a second set of resources within a periodicity; and determine a set of first type of flexible resources in the first set of resources.

In some embodiments, the first configuration information includes a first cell common configuration information, and the second set of resources is indicated by a second cell common configuration information.

In some embodiments, the set of first type of flexible resources include at least one of the following: a set of downlink (DL) slots in the second set of resources that is included in the first set of resources; a set of DL symbols in the second set of resources that is included in the first set of resources; or a set of flexible symbols in the second set of resources that is included in the first set of resources.

In some embodiments, the first set of resources is associated with a set of bandwidth parts (BWPs) which are indicated by a base station (BS), or each of which includes one or more subbands.

In some embodiments, the processor is configured to: receive a third configuration information, and wherein the first type of flexible resources at least include one of the following: a set of DL slots included in the first set of resources that are overridden by flexible symbols by the third configuration information; a set of DL symbols included in the first set of resources that are overridden by flexible symbols by the third configuration information; or a set of flexible symbols included in the first set of resources that are indicated as flexible symbols by the third configuration information.

In some embodiments, the processor is further configured to: receive a fourth configuration information, and wherein the first type of flexible resources include at least a set of flexible symbols included in the first set of resources that are indicated as flexible symbols by the fourth configuration information.

In some embodiments, the set of first type of flexible resources further include at least one of the following, or in response to a configuration of a BS, the set of first type of flexible resources further include at least one of the following: a set of DL slots included in the first set of resources that are indicated as DL slots by the fourth configuration information; or a set of DL symbols included in the first set of resources that are indicated as DL symbols by the fourth configuration information.

In some embodiments, the processor is further configured to: receive a higher layer configured DL transmission in the set of first type of flexible resources in the case that no UL transmission being scheduled in the set of first type of flexible resources; or transmit a higher layer configured UL transmission in the set of first type of flexible resources in the case that no DL transmission being scheduled in the set of first type of flexible resources.

In some embodiments, the higher layer configured DL transmission includes at least one of physical downlink shared channel (PDSCH) transmission or channel state information-reference signal (CSI-RS) transmission.

In some embodiments, the higher layer configured UL transmission includes at least one of sounding reference signal (SRS) transmission, physical uplink control channel (PUCCH) transmission, physical uplink shared channel (PUSCH) transmission, or physical random access channel (PRACH) transmission.

In some embodiments, an UL transmission in the set of first type of flexible resources is transmitted within a configured subband.

In some embodiments, whether an UL transmission in the set of flexible symbols is transmitted in a configured subband or an active BWP based on pre-configuration or configured by a BS.

In some embodiments, the processor is further configured to: determine a set of second type of flexible resources in the second set of resources and out of the first set of resources, wherein the set of second type of flexible resources at least includes a set of flexible symbols in the second set of resources that are out of the first set of resources.

In some embodiments, an UL transmission in the set of second type of flexible resources is transmitted within an active BWP.

In some embodiments, the processor is further configured to: receive a fourth configuration information indicating a set of UL symbols among the first set of resources; and transmit a scheduled UL transmission within a configured subband or an active BWP.

In some embodiments, the processor is configured to: transmit a scheduled UL transmission in the set of second type of flexible resources within an active BWP.

Another embodiment of the present disclosure provides a BS, comprising: a transceiver; and a processor coupled with the transceiver, and the processor is configured to: transmit a first configuration information indicating a first set of resources, wherein the first set of resources includes a part of resources of a second set of resources within a periodicity; and determine a set of first type of flexible resources in the first set of resources.

In some embodiments, the first configuration information includes a first cell common configuration information, and the second set of resources is indicated by a second cell common configuration information.

In some embodiments, the set of first type of flexible resources include at least one of the following: a set of DL slots in the second set of resources that is included in the first set of resources; a set of DL symbols in the second set of resources that is included in the first set of resources; or a set of flexible symbols in the second set of resources that is included in the first set of resources.

In some embodiments, the first set of resources is associated with a set of BWPs which are indicated by the BS, or each of which includes one or more subbands.

In some embodiments, the processor is configured to: transmit a third configuration information, and wherein the first type of flexible resources at least include one of the following: a set of DL slots included in the first set of resources that are overridden by flexible symbols by the third configuration information; a set of DL symbols included in the first set of resources that are overridden by flexible symbols by the third configuration information; or a set of flexible symbols included in the first set of resources that are indicated as flexible symbols by the third configuration information.

In some embodiments, the processor is further configured to: transmit a fourth configuration information indicating a fourth set of resources, and wherein the first type of flexible resources include at least a flexible symbol in the fourth set of resources that is included in the first set of resources.

In some embodiments, the set of first type of flexible resources further include at least one of the following, or in response to a configuration of the BS, the set of first type of flexible resources further include at least one of the following: a DL slot in the fourth set of resources that is included in the first set of resources; or a DL symbol in the fourth set of resources that is included in the first set of resources.

In some embodiments, the processor is configured to: transmit a first higher layer DL transmission in the set of first type of flexible resources in the case that no UL transmission being scheduled in the one or more first type of flexible resources; or receive a second higher layer UL transmission in the set of first type of flexible resources in the case that no DL transmission being scheduled in the one or more first type of flexible resources.

In some embodiments, the first higher layer DL transmission includes at least one of PDSCH transmission or CSI-RS transmission.

In some embodiments, the second higher layer UL transmission includes at least one of SRS transmission, PUCCH transmission, PUSCH transmission, or PRACH transmission

In some embodiments, an UL transmission in the set of first type of flexible resources is transmitted within a configured subband.

In some embodiments, an UL transmission in the flexible symbol is transmitted in an active BWP.

In some embodiments, the processor is further configured to: determine a set of second type of flexible resources in the second set of resources and out of the first set of resources, wherein the set of second type of flexible resources at least includes one or more flexible symbols in the second set of resources that are out of the first set of resources.

In some embodiments, an UL transmission in the set of second type of flexible resources is transmitted within an active BWP.

In some embodiments, the processor is further configured to: transmit a fourth configuration information indicating set of UL symbols among the first set of resources; and receive an scheduled UL transmission within a configured subband or an active BWP.

In some embodiments, the processor is configured to: transmit an scheduled UL transmission in the set of second type of flexible resources within an active BWP.

In some embodiments, the processor is further configured to: transmit at least one of the following information to another BS: the first cell common configuration, the second cell common configuration, the set of BWPs associated with the first set of resources, the subband configuration information including a relative position associated with a starting of associated BWP in frequency domain, or an absolute frequency domain position in a network carrier.

Yet another embodiment of the present disclosure provides a method performed by a UE, comprising: receiving a first configuration information indicating a first set of resources, wherein the first set of resources includes a part of resources of a second set of resources within a periodicity; and determining a set of first type of flexible resources in the first set of resources.

In some embodiments, the first configuration information includes a first cell common configuration information, and the second set of resources is indicated by a second cell common configuration information.

In some embodiments, the set of first type of flexible resources include at least one of the following: a set of DL slots in the second set of resources that is included in the first set of resources; a set of DL symbols in the second set of resources that is included in the first set of resources; or a set of flexible symbols in the second set of resources that is included in the first set of resources.

In some embodiments, the first set of resources is associated with a set of BWPs which are indicated by a BS, or each of which includes one or more subbands.

In some embodiments, the method further includes receiving a third configuration information, and wherein the first type of flexible resources at least include one of the following: a set of DL slots included in the first set of resources that are overridden by flexible symbols by the third configuration information; a set of DL symbols included in the first set of resources that are overridden by flexible symbols by the third configuration information; or a set of flexible symbols included in the first set of resources that are indicated as flexible symbols by the third configuration information.

In some embodiments, the method further includes receiving a fourth configuration information, and wherein the first type of flexible resources include at least a set of flexible symbols included in the first set of resources that are indicated as flexible symbols by the fourth configuration information.

In some embodiments, the set of first type of flexible resources further include at least one of the following, or in response to a configuration of a BS, the set of first type of flexible resources further include at least one of the following: a set of DL slots included in the first set of resources that are indicated as DL slots by the fourth configuration information; or a set of DL symbols included in the first set of resources that are indicated as DL symbols by the fourth configuration information.

In some embodiments, the method further includes receiving a higher layer configured DL transmission in the set of first type of flexible resources in the case that no UL transmission being scheduled in the set of first type of flexible resources; or transmitting a higher layer configured UL transmission in the set of first type of flexible resources in the case that no DL transmission being scheduled in the set of first type of flexible resources.

In some embodiments, the higher layer configured DL transmission includes at least one of PDSCH transmission or CSI-RS transmission.

In some embodiments, the higher layer configured UL transmission includes at least one of SRS transmission, PUCCH transmission, PUSCH transmission, or PRACH transmission.

In some embodiments, an UL transmission in the set of first type of flexible resources is transmitted within a configured subband.

In some embodiments, whether an UL transmission in the set of flexible symbols is transmitted in a configured subband or an active BWP based on pre-configuration or configured by a BS.

In some embodiments, the method further includes determining a set of second type of flexible resources in the second set of resources and out of the first set of resources, wherein the set of second type of flexible resources at least includes a set of flexible symbols in the second set of resources that are out of the first set of resources.

In some embodiments, an UL transmission in the set of second type of flexible resources is transmitted within an active BWP.

In some embodiments, the method further includes receiving a fourth configuration information indicating a set of UL symbols among the first set of resources; and transmitting a scheduled UL transmission within a configured subband or an active BWP.

In some embodiments, the method further includes transmitting a scheduled UL transmission in the set of second type of flexible resources within an active BWP.

Still another embodiment of the present disclosure provides a method performed by a BS, comprising: transmitting a first configuration information indicating a first set of resources, wherein the first set of resources includes a part of resources of a second set of resources within a periodicity; and determining a set of first type of flexible resources in the first set of resources.

In some embodiments, the first configuration information includes a first cell common configuration information, and the second set of resources is indicated by a second cell common configuration information.

In some embodiments, the set of first type of flexible resources include at least one of the following: a set of DL slots in the second set of resources that is included in the first set of resources; a set of DL symbols in the second set of resources that is included in the first set of resources; or a set of flexible symbols in the second set of resources that is included in the first set of resources.

In some embodiments, the first set of resources is associated with a set of BWPs which are indicated by the BS or, each of which includes one or more subbands.

In some embodiments, the method further includes transmitting a third configuration information, and wherein the first type of flexible resources at least include one of the following: a set of DL slots included in the first set of resources that are overridden by flexible symbols by the third configuration information; a set of DL symbols included in the first set of resources that are overridden by flexible symbols by the third configuration information; or a set of flexible symbols included in the first set of resources that are indicated as flexible symbols by the third configuration information.

In some embodiments, the method further includes transmitting a fourth configuration information, and wherein the first type of flexible resources include at least a set of flexible symbols included in the first set of resources that are indicated as flexible symbols by the fourth configuration information.

In some embodiments, the set of first type of flexible resources further include at least one of the following, or in response to a configuration of the BS, the set of first type of flexible resources further include at least one of the following: a set of DL slots included in the first set of resources that are indicated as DL slots by the fourth configuration information; or a set of DL symbols included in the first set of resources that are indicated as DL symbols by the fourth configuration information.

In some embodiments, the method further includes transmitting a higher layer configured DL transmission in the set of first type of flexible resources in the case that no UL transmission being scheduled in the set of first type of flexible resources; or receive a higher layer configured UL transmission in the set of first type of flexible resources in the case that no DL transmission being scheduled in the set of first type of flexible resources.

In some embodiments, the higher layer configured DL transmission includes at least one of PDSCH transmission or CSI-RS transmission.

In some embodiments, the higher layer configured UL transmission includes at least one of SRS transmission, PUCCH transmission, PUSCH transmission, or PRACH transmission

In some embodiments, an UL transmission in the set of first type of flexible resources is transmitted within a configured subband.

In some embodiments, whether an UL transmission in the set of flexible symbols is transmitted in a configured subband or an active BWP based on pre-configuration or configured by a BS.

In some embodiments, the method further includes determining a set of second type of flexible resources in the second set of resources and out of the first set of resources, wherein the set of second type of flexible resources at least includes a set of flexible symbols in the second set of resources that are out of the first set of resources.

In some embodiments, an UL transmission in the set of second type of flexible resources is transmitted within an active BWP.

In some embodiments, the method further includes transmitting a fourth configuration information indicating a set of UL symbols among the first set of resources; and receiving a scheduled UL transmission within a configured subband or an active BWP.

In some embodiments, the method further includes transmitting a scheduled UL transmission in the set of second type of flexible resources within an active BWP.

In some embodiments, the method further includes transmitting at least one of the following information to another BS: the first cell common configuration, the second cell common configuration, the set of BWPs associated with the first set of resources, the subband configuration information including a relative position associated with a starting of the associated BWP in frequency domain, or an absolute frequency domain position in a network carrier.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIGS. 2A-2E illustrate five different duplex modes according to some embodiments of the present disclosure.

FIG. 3 illustrates an exemplary TDD slot format configuration according to some embodiments of the present disclosure.

FIGS. 4A-4E illustrate some exemplary slot format configurations according to some embodiments of the present disclosure.

FIG. 5 illustrates an exemplary subband configuration for one or more bandwidth parts (BWPs) of a carrier according to some embodiments of the present disclosure.

FIG. 6A illustrates a method performed by an apparatus for wireless communication according to some embodiments of the present disclosure.

FIG. 6B illustrates a method performed by an apparatus for wireless communication according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

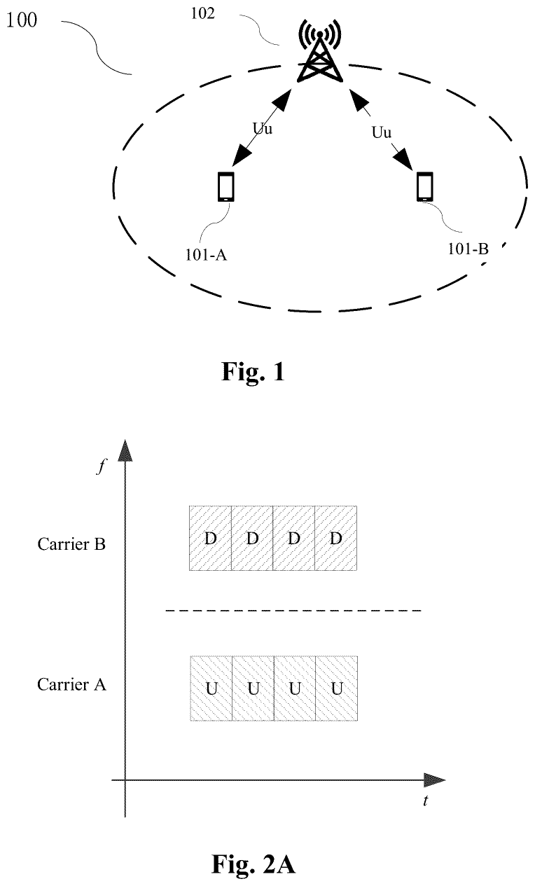

FIG. 1 depicts a wireless communication system 100 according to an embodiment of the present disclosure.

As shown in FIG. 1, the wireless communication system 100 includes two UEs, UE 101-A and UE 101-B, and a BS 102. Even though a specific number of UEs and BSs are depicted in FIG. 1, it is contemplated that any number of UEs and BSs may be included in the wireless communication system 100.

The UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs include wearable devices, such as smart watches, fitness bands, optical head-mounted displays, or the like. Moreover, the UEs may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs may communicate directly with the BSs via uplink (UL) communication signals.

The BSs may be distributed over a geographic region. In certain embodiments, each of the BSs may also be referred to as an access point, an access terminal, a base, a macro cell, a Node-B, an enhanced Node B (eNB), a gNB, a Home Node-B, a relay node, or a device, or described using other terminology used in the art. The BSs are generally part of a radio access network that may include one or more controllers communicably coupled to one or more corresponding BSs.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In one embodiment, the wireless communication system 100 is compatible with the 5G new radio (NR) of the 3GPP protocol, wherein the BSs transmit data using an orthogonal frequency division multiplexing (OFDM) modulation scheme on the downlink and the UEs transmit data on the uplink using discrete Fourier transform-spread-orthogonal frequency division multiplexing (DFT-S-OFDM) or cyclic prefix-orthogonal frequency division multiplexing (CP-OFDM) scheme. More generally, however, the wireless communication system 100 may implement some other open or proprietary communication protocols, for example, WiMAX, among other protocols.

In other embodiments, the BSs may communicate using other communication protocols, such as the IEEE 802.11 family of wireless communication protocols. Further, in some embodiments, the BSs may communicate over licensed spectrums, whereas in other embodiments the BSs may communicate over unlicensed spectrums. The present disclosure is not intended to be limited to the implementation of any particular wireless communication system architecture or protocol. In another embodiment, the BSs may communicate with the UEs using the 3GPP 5G protocols.

Duplex communication means bidirectional communication between two devices, where the transmissions over the link in each direction may take place at the same time (i.e., full duplex) or mutual exclusive time (i.e., half duplex). That is, there are two types of duplex communication, one is the full duplex, which suggests that the transmissions over the link in each direction may take place at the same time, the other is half duplex, which means that the transmissions over the link in each direction may take place at mutual exclusive time.

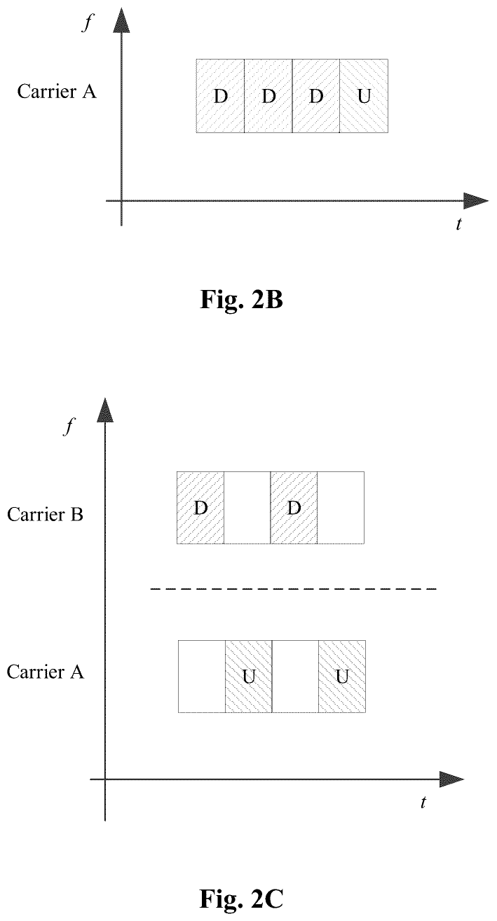

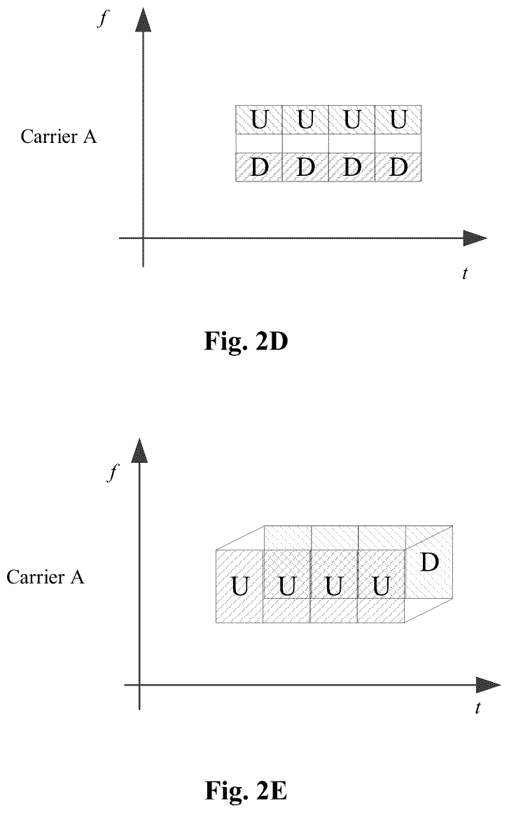

FIGS. 2A-2E illustrate five different duplex modes according to some embodiments of the present disclosure.

In FIGS. 2A-2E, the letter “U” represents the uplink (UL) transmission, such as transmissions from UE to gNB, and the letter “D” represents the downlink (DL) transmission, such as transmissions from gNB to UE. Each block, such as a block marked by letter “D” or “U”, is located within a time duration (e.g., a slot) on a carrier.

FIG. 2A illustrates a full duplex frequency division duplex (FD-FDD) mode. The uplink data is transmitted with carrier A, and the downlink data is transmitted with carrier B, different carrier frequencies are employed for different link directions, respectively. The full duplex is achieved by different carrier frequencies.

FIG. 2B illustrates a time division duplex (TDD) mode. In TDD mode, the link directions are separated by time domain resources. For instance, the downlink transmission is performed in the first three slots on carrier A, and the uplink transmission is performed in the last slot on carrier A.

FIG. 2C illustrates a half-duplex FDD (HD-FDD) mode. In HD-FDD mode, the uplink transmission and downlink transmission are performed on different frequencies within different time duration. As shown in FIG. 2C, the downlink transmission is performed in the first slot and the third slot in time domain on carrier B, and the uplink transmission is performed in the second slot and the fourth slot in time domain on carrier A.

FIGS. 2D and 2E illustrate two full duplex modes which enable transmission and reception by the same device on the same carrier in the same slot. For example, in FIG. 2D, the uplink transmission and downlink transmission occupy different frequency resources on the same carrier, carrier A. For the same slot, there is a gap in frequency domain in FIG. 2D. FIG. 2E illustrates another full duplex mode, the uplink and downlink may fully occupy overlapped resources, and there is no gap in frequency domain.

Simultaneous DL transmission and UL transmission on the same carrier might incur self-interference. At the BS side, the DL transmission might interfere with UL reception, and at the UE side, the UL transmission might interfere with DL reception.

Regarding the two FD modes as described in FIGS. 2D and 2E, since there is a gap in frequency domain in FD mode in FIG. 2D that helps alleviating the interference, the self-interference for the FD mode in FIG. 2D may be lower than that in FIG. 2E.

The present disclosure focuses on subband non-overlapping full duplex at BS side only, the UEs perform data transmission in half duplex mode. The proposals may be applicable for other full duplex modes.

It may be easier and more feasible to realize full duplex at BS side than at UE side, because more room is available at the BS side, which enables separation of transmit antenna branches or receive antenna branches for self-interference cancellation. Besides, more complex and advanced transceiver may be deployed at BS side, which is fundamental for self-interference cancellation.

Full duplex at BS side may impact the UE behavior. On one hand, the slot format determination might be impacted given that full duplex may be expected by the UE in some slots or symbols, while it is not expected in other slots or symbols. On the other hand, with subbands being allocated for full duplex, the UL transmission might be scheduled within different frequency resources in slots or symbols.

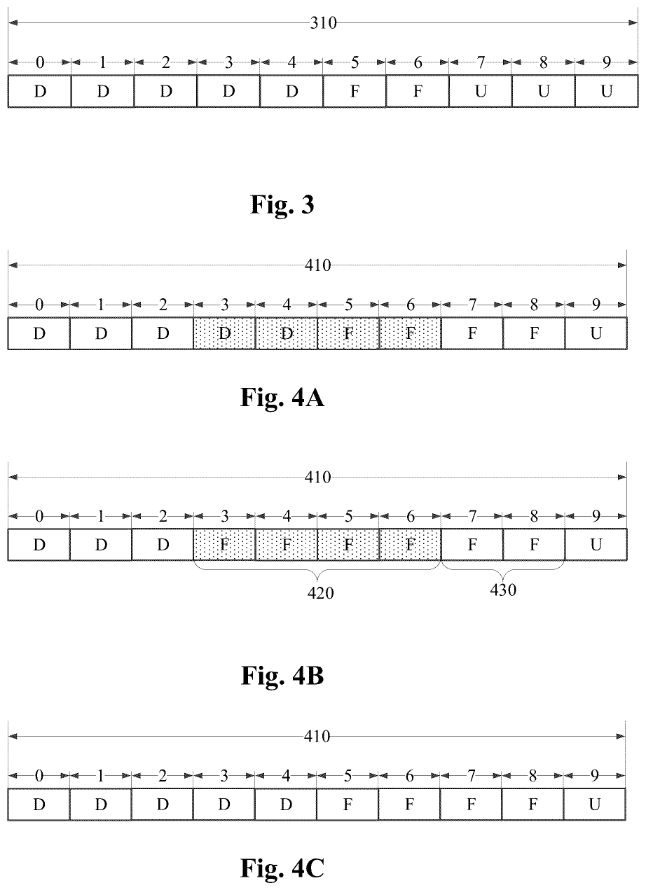

FIG. 3 illustrates an exemplary TDD slot format configuration according to some embodiments of the present disclosure.

The TDD slot format in 5G NR may include downlink symbols, uplink symbols and flexible symbols. In FIG. 3, the TDD slot format may be determined by a cell common UL or DL configuration, which may be referred to as “tdd-UL-DL-ConfigrationCommon,” which may be provided to the UE through a system information block (SIB), for example: SIB1. The parameter “tdd-UL-DL-ConfigrationCommon” may include configurations of a transmission pattern, which may include the following parameters:
a slot configuration period of P millisecond (msec), which may be referred to as: “dl-ul-TransmissionPeriodicity”;
a number of downlink slots, which may be referred to as: “nrofDownlinkSlots”;
a number of downlink symbols, which may be referred to as: “nrofDownlinkSymbols”;
a number of uplink slots, which may be referred to as: “nrofUplinkSlots”; and
a number of uplink symbols, which may be referred to as: “nrofUplinkSymbols”.

The cell UL or DL configuration may indicate that the DL UL transmission periodicity 310 is 5 ms, i.e., the value of the parameter: dl-ul-TransmissionPeriodicity is 5 ms. The length of one slot is 0.5 ms, thus there are 10 slots within the slot configuration period, which may be referred to as: slot #0,slot #1,slot #2, . . . , slot #9.Each slot may include 14 symbols.

The number of downlink slots, is 5, i.e., the value of the parameter: nrofDownlinkSlots is 5, indicating that the first five slots are DL slots, accordingly, the first five slots, slot #0 to slot #4, are downlink slots.

The number of uplink slots, is 3, i.e., the value of the parameter: nrofUplinkSlots is 3, indicating that the last three slots are DL slots, accordingly, the last three slots, slot #7, slot #8, and slot #9, are uplink slots.

The number of downlink symbols and the number of uplink symbols are not configured in FIG. 3.

The remaining symbols within the DL UL transmission periodicity 310 between the DL slots and UL slots are all flexible symbols. That is, the symbols included in slot #5 and slot #6 are all flexible symbols.

In some embodiments, the UE may be further provided with a UE specific RRC signaling, which may be a dedicated slot format configuration for the UE, and may be referred to as: “tdd-UL-DL-ConfigDedicated”. The UE specific RRC signalling tdd-UL-DL-ConfigDedicated may override flexible symbols per slot over the number of slots as provided by the cell common configuration tdd-UL-DL-ConfigCommon. The flexible symbols may be overridden as UL symbols or DL symbols, or may still be indicated as flexible symbols. Regarding the DL symbols, DL slots, UL symbols, or UL slots configured by the cell specific configuration tdd-UL-DL-ConfigCommon, these non-flexible symbols may not be overridden by the UE specific configuration, tdd-UL-DL-ConfigDedicated.

The UE may be further provided with a group UE specific downlink control information (DCI) signalling using DCI format 2_0, which may carry a slot format indicator for the UE. The group UE specific DCI may override the flexible symbols indicated by the cell specific configuration tdd-UL-DL-ConfigCommon, or override the flexible symbols indicated by the UE specific configuration, tdd-UL-DL-ConfigDedicated.

In order to improve the UL performance, the present disclosure proposes to activate more UL resources by full duplex in TDD system. More UL resources may lead to better UL coverage, lower UL transmission latency and improved UL capability.

In the present disclosure, the BS may perform subband non-overlapping full duplex, that is, the BS may perform in the FD mode as described in FIG. 2D. Based on different UE capabilities, there are two types of UEs related. The first type of UE may be referred to as a FD UE, it may support the full duplex at BS side. The BS may know a UE supporting full duplex at BS side through UE capability reporting. A UE with such capability may support full duplex at BS side automatically, or the UE is enabled to support full duplex in BS side through a configuration from BS. The second type of UE may be referred to as a non-FD UE, it may not support the full duplex at BS side. A UE supporting full duplex at BS side means that the UE can receive and successfully interpret the configurations related with full duplex operation. Both FD UE and non-FD UE perform transmission in half duplex mode, and the present disclosure focuses on the FD UEs.

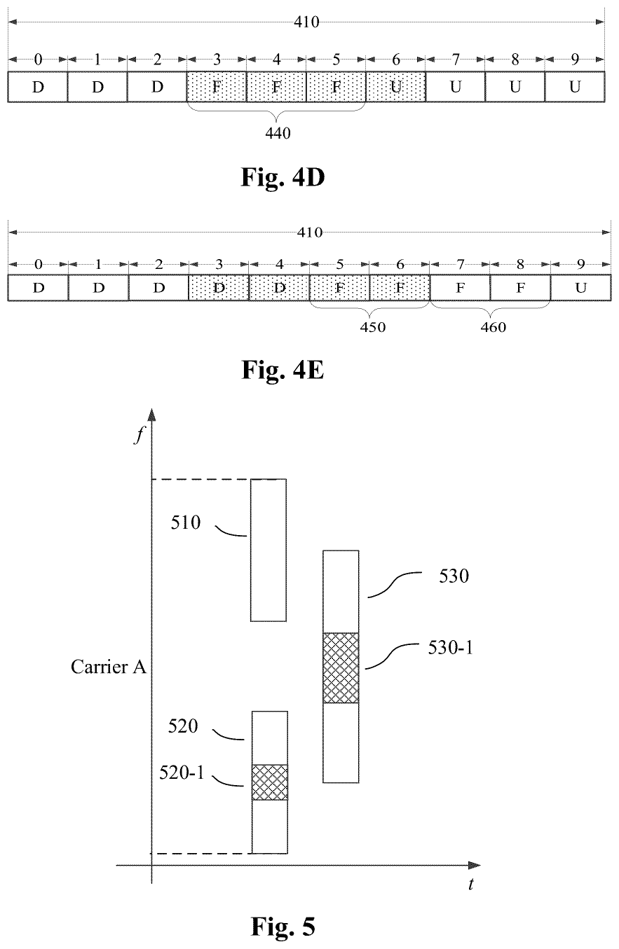

FIGS. 4A-4E illustrate some slot format configurations according to some embodiments of the present disclosure.

FIG. 4A illustrates an exemplary TDD slot format configuration according to some embodiments of the present disclosure.

Referring to FIG. 4A, the set of resources as indicated by the cell specific configuration tdd-UL-DL-ConfigCommon may have a DL UL transmission periodicity 410, within each DL UL transmission periodicity 410, there are five DL slots, i.e., slot #0 to slot #4, one UL slot, i.e., slot #9, and flexible symbols in slot #5 to slot #8.

In addition to the cell common UL or DL configuration above, i.e., tdd-UL-DL-ConfigCommon, the present disclosure proposed to introduce another cell common configuration, which may indicate a set of slots or symbols for the FD UEs. Hereinafter in the present disclosure, the term “first cell common configuration” refers to the introduced cell common configuration, and the term “second cell common configuration” refers to the cell specific configuration tdd-UL-DL-ConfigCommon.

The indicated slots or symbols at least include a first set of resources, which is a part of resources of the second set of resources within the DL UL transmission periodicity 410. For example, the first cell common configuration may indicate a first set of resources including: DL slot #3, DL slot #4, and flexible symbols in slot #5 and slot #6, which include the blocks marked by dots as shown in FIG. 4A.

The first cell common configuration may be included in the system information block (SIB). The first cell common configuration may be per slot configuration period (e.g., per dl-ul-TransmissionPeriodicity) configured and applicable to the slots or symbols of each slot configuration period of the second cell common configuration.

For FD UEs, two types of flexible symbols may be determined based on the first cell common configuration.

In the case that the FD UE is not provided with UE specific UL-DL configuration or group UE specific UL-DL configuration, the UE may determine two types of flexible symbols based on the first cell common configuration and the second cell common configuration.

Type 1 flexible symbols may include at least one of the following:
the DL slots configured by the second cell common configuration and indicated by the first cell common configuration, in other words, the DL slots in the second set of resources that are included in the first set of resources;
the DL symbols configured by the second cell common configuration and indicated by the first cell common configuration, in other words, the DL symbols in the second set of resources that are included in the first set of resources; or
the flexible symbols configured by the second cell common configuration and indicated by the first cell common configuration, in other words, the flexible symbols in the second set of resources that are included in the first set of resources.

For example, referring to FIG. 4B, which illustrates an exemplary TDD slot format configuration for a FD UE, slot #3 and slot #4 are configured as DL slots by the second cell common configuration, and slot #3 and slot #4 are also indicated by the first cell common configuration, thus the two DL slots are determined as type 1 flexible symbols by the FD UE. The flexible symbols in slot #5 and slot #6 are configured as flexible symbols by the second cell common configuration, and the flexible symbols in slot #5 and slot #6 are also indicated by the first cell common configuration, thus the flexible symbols in slot #5 and slot #6 are determined as type 1 flexible symbols by the FD UE. To sum up, the set of resources 420 (i.e., type 1 flexible symbols) includes flexible symbols in slot #3 to slot #6.

Type 2 flexible symbols may include flexible symbols configured by the second cell common configuration and not indicated by the first cell common configuration, in other words, the flexible symbols in the second set of resources that are not included in the first set of resources.

For example, referring to FIG. 4B, flexible symbols in slot #7 to slot #8 are configured as flexible symbols by the second cell common configuration, and the flexible symbols in slot #7 to slot #8 are not indicated by the first cell common configuration, thus the flexible symbols in slot #7 to slot #8 are determined as type 2 flexible symbols 430 by the FD UE. To sum up, the set of resources 430 (i.e., type 2 flexible symbols) includes flexible symbols in slot #7 and slot #8.

For non-FD UEs, the slot format is as shown in FIG. 4C. As shown in FIG. 4C, the non-FD UEs determine the slot format based on the second cell configuration, and may have a DL UL transmission periodicity 410, within each DL UL transmission periodicity 410, there are five DL slots, i.e., slot #0 to slot #4, one UL slot, i.e., slot #9, and flexible symbols in slot #5 to slot #8.

In some embodiments, the FD UE may be provided with UE specific UL-DL configuration or group UE specific UL-DL configuration.

The UE specific UL-DL configuration may be carried in a radio resource control (RRC) signalling, a media access control (MAC) signalling, or a physical layer (PHY) signalling (i.e., a dedicated DCI format). Hereinafter in the present disclosure, the UE specific UL-DL configuration may also be referred to as the third configuration.

The group UE specific UL-DL configuration may be indicated by DCI format 2_0, which has been specified for the non-FD UEs for dynamic slot format indication. Alternatively, the group UE specific UL-DL configuration may be indicated by a DCI dedicated for FD-UEs. In some embodiments, the FD UEs and non-FD UEs may be separately grouped, and the group UE specific UL-DL configuration may indicate one slot format for the grouped FD UEs and indicate another slot format for the grouped non-FD UEs. Alternatively, to save the signaling overhead, the FD UEs and non-FD UEs may be grouped together, and the group UE specific UL-DL configuration indicate the same slot format for both the FD UEs and the non-FD UEs. Hereinafter in the present disclosure, the group UE specific UL-DL configuration may also be referred to as the fourth configuration.

The UE specific UL-DL configuration or the group UE specific UL-DL configuration may override the slot format indicated by the second cell common configuration, thus the UE may determine the slot format based on at least one of the following: 1) the first cell common configuration; 2) the second cell common configuration; 3) the UE specific UL-DL configuration; or 4) the group UE specific UL-DL configuration. The type 1 flexible symbols and type 2 flexible symbols may be determined as follows:

Type 1 flexible symbols may include at least one of the following:
the DL slots or DL symbols that are configured by the second cell common configuration, overridden by flexible symbols according to the UE specific UL-DL configuration or group the UE specific UL-DL configuration, and are indicated by the first cell common configuration, in other words, the DL slots or DL symbols that are included in the first set of resources that are overridden by flexible symbols by the third configuration information or by the fourth configuration information.
the DL slots or DL symbols that are configured by the second cell common configuration, indicated as DL slots or DL symbols by group UE specific UL-DL configuration (the group UE specific UL-DL configuration is for a group including both FD UEs and non-FD UEs), and are indicated by the first cell common configuration, in other words, the DL slots or DL symbols that are included in the first set of resources that are overridden by DL slots or DL symbols by the fourth configuration information.

Because the group UE specific UL-DL configuration is for a group including both FD UEs and non-FD UEs, full duplex is allowed in the DL slots or DL symbols indicated by the first cell common configuration, therefore, these DL slots or DL symbols may be determined as the type 1 flexible symbols.

Alternatively, whether these DL slots or DL symbols may be determined as the type 1 flexible symbols by FD UEs are based on the configuration of the BS, or pre-configuration.
the flexible symbols that are indicated as flexible by the UE specific UL-DL configuration or group UE specific UL-DL configuration, in other words, a set of flexible symbols included in the first set of resources that are indicated as flexible symbols by the third configuration information or by the fourth configuration information.

Type 2 flexible symbols may include flexible symbols that are not indicated by the first cell common configuration.

Regarding the third configuration or the fourth configuration overriding the slot format, there may be the following cases:
If an indicated DL slot or symbol or a flexible symbol is indicated as DL in the UE specific UL-DL configuration or group UE specific UL-DL configuration (FD-UEs and non-FD UEs are separately grouped), the FD-UEs determines the slot or symbol as a DL slot or symbol.
If an indicated flexible symbol is indicated as UL in the UE specific UL-DL configuration or group UE specific UL-DL configuration, the FD UEs determines the flexible symbol as UL symbol.

FIG. 4D illustrates an exemplary TDD slot format configuration according to some embodiments of the present disclosure.

In FIG. 4D, the FD UE may first receive the second cell common configuration, which may indicate a slot format index. A slot format may be identified by the slot format index in a table including a plurality of slot format, for example, the slot format index may correspond to a slot format “DDDDDFFFFU,” wherein the letter “D” denotes a downlink symbol, the letter “U” denotes an uplink symbol, and the letter “F” denotes a slot with flexible symbols. The FD UE determines the UL-DL configuration of the slots as follows: 10 slots are included in a DL UL transmission periodicity, slot #0 to slot #4 are DL slots, the symbols in slot #5 to slot #8 are flexible symbols, and slot #9 is an UL slot.

The FD UE may be further provided with a UE specific UL-DL configuration, tdd-UL-DL-ConfigDedicated, which may configure a slot format as “DDDFFFUUUUU”, that is: the configuration indicates that 10 slots are included in a DL UL transmission periodicity, slot #0 to slot #2 are DL slots, the symbols in slot #3 to slot #5 are flexible symbols, and slot #6 to slot #9 are UL slots. The UE specific UL-DL configuration overrides the second cell common configuration. Alternatively, the FD UE may be provided with a group UE specific UL-DL configuration by DCI format 2_0, which also configure the same slot format, and the group UE specific UL-DL configuration also overrides the second cell common configuration.

The first cell common configuration indicates the slots or symbols in slot #3 to slot #6. Referring to FIG. 4D, the symbols in slot #3, slot #4, slot #5 are flexible symbols indicated by the UE specific UL-DL configuration, and are also indicated by the first cell common configuration, thus symbols in slot #3, slot #4, and slot #5 are determined as the type 1 flexible symbols by the FD UE. To sum up, the set of resources 440 (i.e., type 1 flexible symbols) includes flexible symbols in slot #3, slot #4, and slot #5, and there are no type 2 flexible symbols.

FIG. 4E illustrates another exemplary TDD slot format configuration according to some embodiments of the present disclosure.

In addition to the second cell common configuration, the FD UE may be further provided with a UE specific UL-DL configuration, tdd-UL-DL-ConfigDedicated, which may configure a slot format as “DDDDDFFFFU”, that is: slot #0 to slot #4 are DL slots, the symbols in slot #5 to slot #8 are flexible symbols, and slot #9 is an UL slot. The UE specific UL-DL configuration overrides the second cell common configuration. Alternatively, the FD UE may be provided with a group UE specific UL-DL configuration by DCI format 2_0, which also configure the same slot format, and the group UE specific UL-DL configuration also overrides the second cell common configuration.

The first cell common configuration indicates the slots or symbols in slot #3 to slot #6. Referring to FIG. 4E, the symbols in slot #5 and slot #6 are flexible symbols indicated by the UE specific UL-DL configuration, and are determined as the type 1 flexible symbols by the FD UE. The symbols in slot #7 and slot #8 are flexible symbols indicated by the UE specific UL-DL configuration, and are not indicated by the first cell common configuration, thus flexible symbols in slot #7 and slot #8 are determined as the type 2 flexible symbols by the FD UE. In conclusion, the set of resources 450 (i.e., type 1 flexible symbols) includes flexible symbols in slot #5 and slot #6, the set of resources 460 (i.e., type 2 flexible symbols) in FIG. 4E includes flexible symbols in slot #7 and slot #8.

Regarding the two types of flexible symbols, the FD UE's behavior may be different.

In type 1 flexible symbols, from FD UE's perspective, full duplex at BS side is expected. In other words, DL transmissions and UL transmissions may happen simultaneously in type 1 flexible symbols at BS side.

In type 2 flexible symbols, from FD UE's perspective, full duplex at BS side is not expected. In other words, DL transmissions and UL transmissions may not happen simultaneously in type 2 flexible symbols at BS side. The UE behavior of FD-UEs in type 2 flexible symbols is same as the non-FD UEs, since the non-FD UEs do not support full duplex at BS side.

For higher layer configured DL transmission (which may include: physical downlink shared channel (PDSCH) transmission, channel state information-reference signal (CSI-RS) transmission, etc.) and for higher layer configured UL transmission (which may include: sounding reference signal (SRS) transmission, or physical uplink control channel (PUCCH) transmission, or physical uplink shared channel (PUSCH) transmission, or physical random access channel (PRACH) transmission), they are allowed in type 1 flexible symbols while they are not allowed in the type 2 flexible symbols.

For type 2 flexible symbols, full duplex is not expected at BS side, therefore, if higher layer configured DL transmission or higher layer configured UL transmission is allowed in type 2 flexible symbols, these flexible symbols are not flexible anymore, and they can only be scheduled for DL transmission or UL transmission. For type 1 flexible symbols, full duplex is expected at BS side, therefore higher layer configured DL transmission or higher layer configured UL transmission is allowed in type 1 flexible symbols.

In the case that the FD UE is not provided with UE specific UL-DL configuration or group UE specific UL-DL configuration, the FD UE may perform the higher layer configured DL transmission or higher layer configured UL transmission in type 1 flexible symbols as follows:
Case A1: the FD UE may receive at least one of PDSCH or CSI-RS in type 1 flexible symbols if the FD UE receives a corresponding indication by a DCI format. The UE behavior for the non-FD UE may be the same.
Case A2: the FD UE may transmit PUSCH, PUCCH, PRACH, or SRS in type 1 flexible symbols if the FD UE receives a corresponding indication by at least one of a DCI format, a random access response (RAR) UL grant, a fallback RAR UL grant, or a success RAR. The transmission is within the configured subband. The UE behavior for the non-FD UE may be the same.
Case A3: the FD UE may receive PDCCH in type 1 flexible symbols if there is no UL scheduling in type 1 flexible symbols. The UE behavior for the non-FD UE may be the same.
Case A4: the FD UE may be configured by higher layers to receive at least one of PDSCH or CSI-RS in type 1 flexible symbols, and if there is no UL scheduling in type 1 flexible symbols, the FD UE may receive at least one of PDSCH or CSI-RS in type 1 flexible symbols. For non-FD UEs, the non-FD UE may not receive the PDSCH or CSI-RS in type 1 flexible symbols in this case.
Case A5: the FD UE may be configured by higher layers to transmit at least one of SRS, or PUCCH, or PUSCH, or PRACH in type 1 flexible symbols, if there is no DL scheduling in type 1 flexible symbols, the FD UE may transmit at least one of SRS, or PUCCH, or PUSCH, or PRACH in type 1 flexible symbols. For non-FD UEs, the non-FD UE may not transmit at least one of SRS, or PUCCH, or PUSCH, or PRACH in type 1 flexible symbols in this case.

In the case that the FD UE is provided with at least one of UE specific UL-DL configuration or group UE specific UL-DL configuration (hereinafter “at least one of UE specific UL-DL configuration or group UE specific UL-DL configuration” may be referred to as “DCI format 2_0” for short, and it should be noted that the term “DCI format 2_0” may be replaced by any one of “UE specific UL-DL configuration” or “group UE specific UL-DL configuration”), the FD UE may perform the higher layer configured DL transmission or higher layer configured UL transmission as follows:
Case B1: one or more symbols from the set of type 1 flexible symbols are symbols in a control-resource set (CORESET) configured to the FD UE for PDCCH monitoring, the FD UE may receive PDCCH in the CORESET only if the DCI format 2_0 indicates that the one or more symbols are downlink symbols. The UE behavior for the non-FD UE may be the same.
Case B2: the DCI format 2_0 indicates the set of type 1 flexible symbols of the slot as flexible, and the FD UE detects another DCI format, which indicates the FD UE to receive at least one of PDSCH or CSI-RS in type 1 flexible symbols, the FD UE may receive at least one of PDSCH or CSI-RS in type 1 flexible symbols. The UE behavior for the non-FD UE may be the same. For example, referring to FIG. 4E, when a UE (including FD UE and non-FD UE) receives a DCI format indicating the UE to receive PDSCH in flexible symbols in slot #5, the UE may receive PDSCH in flexible symbols in slot #5.
Case B3: the DCI format 2_0 indicates the set of type 1 flexible symbols of the slot as flexible, and the FD UE detects another at least one of DCI format, a RAR UL grant, a fallback RAR UL grant, or a success RAR, which indicates the UE to transmit at least one of PUSCH, PUCCH, PRACH, or SRS in type 1 flexible symbols, the FD UE may transmit at least one of PUSCH, PUCCH, PRACH, or SRS in type 1 flexible symbols within the configured subband. For the non-FD UEs, they may also transmit the PUSCH, PUCCH, PRACH, or SRS in the flexible symbols, but the transmission is not within the configured subband. For example, referring to FIG. 4E, when the FD UE receives a DCI format indicating the FD UE to transmit PUSCH in flexible symbols in slot #5, the UE may transmit PUSCH in flexible symbols in slot #5 within the configured subband. For a non-FD UE, it may transmit PUSCH in flexible symbols in slot #5 within the UL active BWP.
Case B4: the DCI format 2_0 indicates the set of type 1 flexible symbols of the slot as flexible, and the FD UE does not detect another DCI format, which indicates the FD UE to receive at least one of PDSCH or CSI-RS, or the FD UE does not detect at least one of another DCI format, a RAR UL grant, a fallback RAR UL grant, or a success RAR grant, which indicates the FD UE to transmit at least one of PUSCH, PUCCH, PRACH, or SRS in type 1 flexible symbols, the FD UE does not receive PDSCH or CSI-RS, or transmit at least one of PUSCH, PUCCH, PRACH, or SRS, in type 1 flexible symbols. The UE behavior for the non-FD UE may be the same.
Case B5: the FD UE may be configured by higher layers to receive at least one of PDSCH or CSI-RS in type 1 flexible symbols, the FD UE may receive the at least one of PDSCH or the CSI-RS in type 1 flexible symbols if the DCI format 2_0 indicates the set of symbols of the slot as downlink, or if there is no UL transmission scheduled in type 1 flexible symbols. For non-FD UEs, they may only receive PDSCH or CSI-RS when the DCI indicates the set of symbols as downlink.

For example, referring to FIG. 4D, when higher layer configured DL transmission, i.e., at least one of PDSCH or CSI-RS, is configured in slot #3, slot #4, and slot #5, the FD UE may receive the higher layer configured DL transmission if there is no UL scheduling in slot #3, slot #4, or slot #5. Referring to FIG. 4E, when higher layer configured DL transmission, i.e., at least one of PDSCH or CSI-RS, is configured in slot #5 and slot #6, the FD UE may receive the higher layer configured DL transmission if there is no UL scheduling in slot #5 or slot #6.
Case B6: the FD UE may be configured by higher layers to transmit at least one of PUCCH, or PUSCH, or PRACH in type 1 flexible symbols, the FD UE may transmit at least one of PUCCH, or the PUSCH, or the PRACH in the slot if the DCI format 2_0 indicates the set of symbols of the slot as uplink, or if there is no DL scheduling in type 1 flexible symbols. For non-FD UEs, they may only transmit at least one of PUCCH, or PUSCH, or PRACH only if the DCI indicates the set of symbols as uplink.
For example, referring to FIG. 4D, when higher layer configured UL transmission, i.e., at least one of PUCCH, or PUSCH, or PRACH, is configured in slot #3, slot #4, and slot #5, the FD UE may transmit the higher layer configured UL transmission if there is no DL scheduling in slot #3, slot #4, or slot #5. Referring to FIG. 4E, when higher layer configured DL transmission, i.e., at least one of PUCCH, or PUSCH, or PRACH, is configured in slot #5 and slot #6, the FD UE may transmit the higher layer configured UL transmission if there is no DL scheduling in slot #5 or slot #6.

FIG. 5 illustrates an exemplary subband configuration for one or more BWPs of a carrier according to some embodiments of the present disclosure.

Within carrier A for a FD UE, three UL BWPs may be configured. BWP #510 does not have a subband configuration, while BWP #520 has a subband, for example, subband #520-1, which includes a part of frequency resources within BWP #520. For instance, the bandwidth of BWP #520 may be 20 MHz, and the bandwidth of BWP #520-1 is 5 MHz, and is within the bandwidth of BWP #520. BWP #530 may also has a subband, e.g., subband #530-1, other numbers of subbands may be configured. The FD UE may perform transmission within a subband, for example, subband #520-1, or within an active BWP, for example, BWP #520. The BS may indicate the FD UE to switch active BWP, for example, from BWP #520 to BWP #510.

For type 1 flexible symbols, subband non-overlapping full duplex at BS side is expected at FD UE side, and the first cell common configuration may be applied to a BWP with subband(s). Accordingly, the first cell common configuration may be applied to BWP #520 and BWP #530, and may not be applied to BWP #510. If the FD UE switches the active BWP to BWP #510, the UE behavior of the FD UE would be the same with that of the non-FD UEs.

Alternatively, the BS may indicate that the first cell common configuration may be applied to BWP #510, then it is applied to BWP #510 although it does not have a subband.

In some embodiments, the first cell common configuration may be applied to a UL BWP with subband, and the available resource for UL transmission in frequency domain (i.e., subband or BWP for UL transmission) may depend on the slot format of the slots or symbols indicated by the first cell common configuration.

In the case that the UL transmission is scheduled in the indicated DL slots or DL symbols that are determined as type 1 flexible symbols, the UL transmission may be performed within the configured subband. For example, referring to FIG. 4B, when UL transmission is scheduled in slot #3 and slot #4, which are DL slots indicated by the second cell common configuration, and determined as type 1 flexible symbols based on the first cell common configuration, the UL transmission may be performed within the configured subband, such as subband #520-1 as shown in FIG. 5.

In the case that the UL transmission is scheduled in the indicated flexible symbols that are determined as type 1 flexible symbols, it may be predefined or configured whether the UL transmission is to be transmitted within the subband, or to be transmitted within the active UL BWP. For example, referring to FIG. 4B, when UL transmission is scheduled in slot #5 and slot #6, which are flexible symbols indicated by the second cell common configuration, and determined as type 1 flexible symbols based on the first cell common configuration, the UL transmission may be performed within the configured subband, such as subband #520-1 as shown in FIG. 5, or within the active BWP. Supposing the active BWP is BWP #520, the UL transmission may be performed within BWP #520.

In the case that the UL transmission is scheduled in the indicated flexible symbols that are overridden as UL symbols by the UE specific UL-DL configuration or group UE specific UL-DL configuration, the UL transmission may be performed within the configured subband. For example, referring to FIG. 4D, symbols in slot #6 are configured as flexible symbols by the second cell common configuration, are indicated by the first cell common configuration, and overridden by the UE specific UL-DL configuration as UL, when UL transmission is scheduled in slot #6, it may be performed within the configured subband. Alternatively, since both FD UEs and non-FD UEs treat the symbols as UL, the UL transmission may be performed within the active BWP.

In the case that the UL transmission is scheduled in the indicated flexible symbols that are determined as type 2 flexible symbols, the UL transmission is expected to be within the active BWP. For example, referring to FIG. 4B, symbols in slot #7 and slot #8 are configured as flexible symbols by the second cell common configuration, and are not indicated by the first cell common configuration, and they are determined as type 2 flexible symbols. When UL transmission is scheduled in slot #7 and slot #8, it may be performed within active BWP.

In some other embodiments, when the first cell common configuration is applied to a BWP, and the BWP does not include a subband, the UL transmission is performed within the BWP.

For the subband configuration, in one embodiment, the configuration of a subband might be included in the configuration of an associated BWP. The position of a subband is the relative position referring to the starting of the associated BWP in frequency domain. As another option, the position of a subband is the absolute frequency domain position in the network carrier. For the latter case, a subband may be included in or associated with one or more BWPs. In some embodiments, the first configuration information might be included in the subband configuration. Different subband might be associated with different resources indicated by the first configuration information.

Besides self-interference, another challenge in full duplex system is cross link interference, which may include inter-BS cross link interference and inter-UE cross link interference. The former comes from DL transmission in one BS contaminates UL reception in another BS and the latter is from UL transmission from a UE in one cell contaminates the DL reception of a UE from another cell.

The present disclosure also proposes to exchange information among BSs for cross link interference management in full duplex system.

To help the interference management, the cell common configuration of the set of slots or symbols for FD-UEs may be transmitted from one BS to another BS through Xn interface, or forwarded by core network. That is, the BS may transmit the first cell common configuration to another BS.

In some embodiments, the BWPs that the first cell common configurations may be applied to (e.g., index of the BWP, or BWP has one or more subbands) are transmitted.

In some other embodiments, the subband configuration, e.g., the position in frequency domain may be transmitted.

Such information exchange may help interference management in each cell. For example, when a BS receives such information from a neighboring BS, it may not schedule DL transmission within the indicated subband. Accordingly, the UL transmission in the subband from a UE from the neighboring cell may not interfere DL reception of a UE in the cell. Meanwhile, the DL transmission from the neighbouring cell may not interfere the UL reception of the cell in the subband.

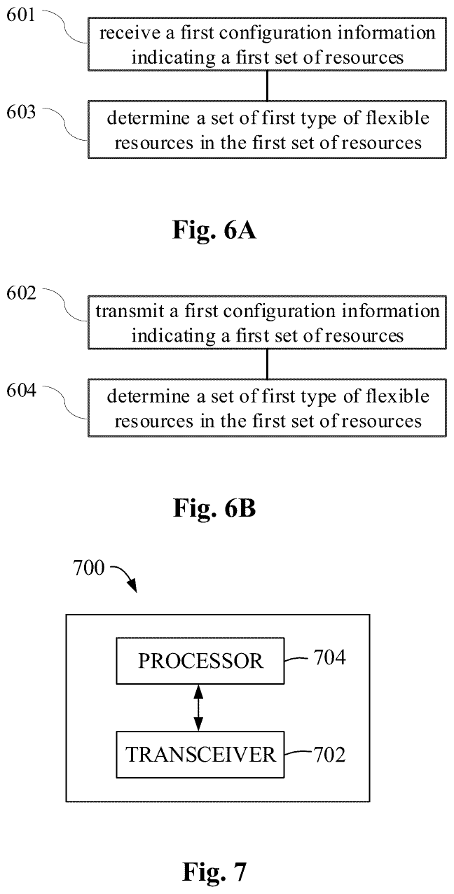

FIG. 6A illustrates a flow chart of an exemplary procedure of wireless communications in accordance with some embodiments of the present disclosure. Details described in all of the foregoing embodiments of the present disclosure are applicable for the embodiments shown in FIG. 6A. In some examples, the procedure may be performed by a UE, for example, UE 101 in FIG. 1.

In operation 601, the UE may receive a first configuration information indicating a first set of resources, wherein the first set of resources includes a part of resources of a second set of resources within a periodicity; and in operation 603, the UE may determine a set of first type of flexible resources in the first set of resources. For example, referring to FIG. 4B, the UE may determine the set of resources 420 (i.e., type 1 flexible symbols) includes flexible symbols in slot #3 to slot #6.

FIG. 6B illustrates a flow chart of an exemplary procedure of wireless communications in accordance with some embodiments of the present disclosure. Details described in all of the foregoing embodiments of the present disclosure are applicable for the embodiments shown in FIG. 6A. In some examples, the procedure may be performed by a BS, for example, BS 102 in FIG. 1.

In operation 602, the BS may transmit a first configuration information indicating a first set of resources, wherein the first set of resources includes a part of resources of a second set of resources within a periodicity; and in operation 604, the BS may determine a set of first type of flexible resources in the first set of resources.

FIG. 7 illustrates a simplified block diagram of an exemplary apparatus according to some embodiments of the present disclosure.

FIG. 7 illustrates a block diagram of an exemplary apparatus 700 according to some embodiments of the present disclosure. As shown in FIG. 7, the apparatus 700 may include at least one processor 704 and at least one transceiver 702 coupled to the processor 704. The apparatus 700 may be a UE or a BS.

Although in this figure, elements such as the at least one transceiver 702 and processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations with respect to the UE described in FIGS. 1-6B. In some embodiments of the present disclosure, the apparatus 700 may be a BS. The transceiver 702 and the processor 704 may interact with each other so as to perform the operations with respect to the BS described in FIGS. 1-6B.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement the method with respect to the UE as described above. For example, the computer-executable instructions, when executed, cause the processor 704 interacting with transceiver 702 to perform the operations with respect to the UE described in FIGS. 1-6B.

In some embodiments of the present disclosure, the non-transitory computer-readable medium may have stored thereon computer-executable instructions to cause the processor 704 to implement the method with respect to the BS as described above. For example, the computer-executable instructions, when executed, cause the processor 704 interacting with transceiver 702 to perform the operations with respect to the BS described in FIGS. 1-6B.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a first configuration information indicating a first set of resources, wherein the first set of resources includes a part of resources of a second set of resources within a periodicity; and
determine a set of first type of flexible resources in the first set of resources.

2. The UE of claim 1, wherein the first configuration information includes a first cell common configuration information, and the second set of resources is indicated by a second cell common configuration information.

3. The UE of claim 1, wherein the set of first type of flexible resources include at least one of the following:
a set of downlink (DL) slots in the second set of resources that is included in the first set of resources;
a set of DL symbols in the second set of resources that is included in the first set of resources; or
a set of flexible symbols in the second set of resources that is included in the first set of resources.

4. The UE of claim 1, wherein the first set of resources is associated with a set of bandwidth parts (BWPs) that are indicated by a base station (BS), or each of which includes one or more subbands.

5. The UE of claim 1, wherein the at least one processor is further configured to cause the UE to:
receive a third configuration information, wherein the first type of flexible resources at least include one of the following:
a set of downlink (DL) slots included in the first set of resources that are overridden by flexible symbols by the third configuration information;
a set of DL symbols included in the first set of resources that are overridden by flexible symbols by the third configuration information; or
a set of flexible symbols included in the first set of resources that are indicated as flexible symbols by the third configuration information.

6. The UE of claim 1, wherein the at least one processor is further configured to cause the UE to:
receive a fourth configuration information, and wherein the first type of flexible resources include at least a set of flexible symbols included in the first set of resources that are indicated as flexible symbols by the fourth configuration information.

7. The UE of claim 6, wherein the set of first type of flexible resources further comprises:
a set of downlink (DL) slots included in the first set of resources that are indicated as DL slots by the fourth configuration information; or
a set of DL symbols included in the first set of resources that are indicated as DL symbols by the fourth configuration information.

8. The UE of claim 1, wherein the at least one processor is further configured to cause the UE to:
receive a higher layer configured downlink (DL) transmission in the set of first type of flexible resources in the case that no uplink (UL) transmission is scheduled in the set of first type of flexible resources; or
transmit a higher layer configured UL transmission in the set of first type of flexible resources in the case that no DL transmission is scheduled in the set of first type of flexible resources.

9. The UE of claim 1, wherein an uplink (UL) transmission in the set of first type of flexible resources is transmitted within a configured subband.

10. The UE of claim 1, wherein the at least one processor is further configured to cause the UE to:
determine a set of second type of flexible resources in the second set of resources and from the first set of resources, wherein the set of second type of flexible resources includes at least a set of flexible symbols in the second set of resources that are from the first set of resources.

11. The UE of claim 10, wherein an uplink (UL) transmission in the set of second type of flexible resources is transmitted within an active bandwidth part (BWP).

12. The UE of claim 1, wherein the at least one processor is further configured to cause the UE to:
receive a fourth configuration information indicating a set of uplink (UL) symbols among the first set of resources; and
transmit a scheduled UL transmission within a configured subband or an active bandwidth part (BWP).

13. The UE of claim 10, wherein the at least one processor is further configured to cause the UE to:
transmit a scheduled uplink (UL) transmission in the set of second type of flexible resources within an active bandwidth part (BWP).

14. A Base Station (BS) for wireless communication, comprising:
at least one memory; and
at least one processor coupled with the at least one memory and configured to cause the BS to:
transmit a first configuration information indicating a first set of resources, wherein the first set of resources includes a part of resources of a second set of resources within a periodicity; and
determine a set of first type of flexible resources in the first set of resources.

15. (canceled)

16. The UE of claim 1, wherein the periodicity is a downlink uplink transmission periodicity.

17. A processor for wireless communication, comprising:
at least one controller coupled with at least one memory and configured to cause the processor to:
receive a first configuration information indicating a first set of resources, wherein the first set of resources includes a part of resources of a second set of resources within a periodicity; and
determine a set of first type of flexible resources in the first set of resources.

18. The processor of claim 17, wherein the first configuration information includes a first cell common configuration information, and the second set of resources is indicated by a second cell common configuration information.

19. The processor of claim 17, wherein the set of first type of flexible resources include at least one of the following:
a set of downlink (DL) slots in the second set of resources that is included in the first set of resources;
a set of DL symbols in the second set of resources that is included in the first set of resources; or
a set of flexible symbols in the second set of resources that is included in the first set of resources.

20. The processor of claim 17, wherein the first set of resources is associated with a set of bandwidth parts (BWPs) that are indicated by a base station (BS), or each of which includes one or more subbands.

21. A method performed by a user equipment (UE), the method comprising:
receiving a first configuration indicating a first set of resources,
wherein the first set of resources includes a part of resources of a second set of resources within a periodicity; and
determining a set of first type of flexible resources in the first set of resources.
